(19) United States
(12) Patent Application Publication
(10) Pub. No.: US 2020/0234162 A1
(43) Pub. Date: Jul. 23, 2020

(54) MACHINE LEARNING PIPELINE FAILURE PREDICTION

(71) Applicant: ServiceNow, Inc., Santa Clara, CA (US)

(72) Inventors: Baskar Jayaraman, Fremont, CA (US); Aniruddha Madhusudan Thakur, Saratoga, CA (US); Sriram Palapudi, Santa Clara, CA (US); Hongqiao Li, Santa Clara, CA (US)

(21) Appl. No.: 16/254,033

(22) Filed: Jan. 22, 2019

(51) Int. Cl. G06N 5/04; G06N 20/00

(52) U.S. Cl. CPC G06N 5/048; G06N 20/00

(57) ABSTRACT

A system is provided that includes a memory containing a target data set, a software application configured to apply a machine learning (ML) pipeline to an input data set, and a computing device. The computing device is configured to obtain, from the memory, the target data set; apply the ML pipeline to the target data set, and provide an indication of the determined inadequacy of the target data set. Applying the ML pipeline results in at least one of generation of an ML model from the target data set or determination of an inadequacy of the target data set. Determining an inadequacy of the target data set includes determining that generation of the ML model failed or that ML model generation would result in a deficient ML model, and determining that the target data set is inadequate in a manner related to the determined failure metric.

### BACKGROUND

Machine learning (ML) systems often use extensive data sets for training of ML models. These models are then tested and deployed for production use. But ML systems are highly sensitive to the quality of their training data sets. If such a data set contains anomalies, errors, or undesirable or non-representative statistical characteristics, the resulting model will have limited value at best. In the worst case, the model will provide misleading or useless results. Since the amount of time to train a model can be on the order or hours or days, it is desirable to be able to avoid these situations.

### SUMMARY

The embodiments herein provide methods for predicting that generation of an ML model is likely to fail and/or providing data-based context for the reason(s) that such generation failed. The pipeline prepares and analyzes the training data before attempting to build an ML model using this data. At multiple points along the pipeline, descriptive statistics are determined and compared to known baselines. If the statistics deviate from the baseline by more than a threshold amount and/or if the statistics conform to a “failure” baseline by more than a threshold amount, ML model generation may be terminated. Additionally or alternatively, an indication of the failure-related statistics may be provided to a user, such that the user may modify the ML model building process and/or the data set used to build the ML model in order to facilitate successful model creation. The statistics may include a variety of information about the structure and content of data used to generate an ML model, e.g., the density of the data, the proportion of the data that is unique (i.e., non-repeated entries), the distribution of to-be-predicted columns of the data, or other information.

Accordingly, a first example embodiment may involve a system that includes: (i) a memory containing a target data set; (ii) a software application configured to apply an ML pipeline to an input data set, wherein the ML pipeline includes a data pre-processing phase and an ML model building phase, wherein the data pre-processing phase generates a conditioned data set from the input data set, wherein the ML model building phase generates an ML model from the conditioned data set, and wherein the software application is additionally configured to generate a failure metric for at least one phase in the ML pipeline; and (iii) a computing device. The computing device is configured to: (a) obtain, from the memory, the target data set; (b) apply the ML pipeline to the target data set, wherein applying the ML pipeline results in at least one of generation of an ML model from the target data set or determination of an inadequacy of the target data set, wherein determining an inadequacy of the target data set includes determining that generation of the ML model failed or that ML model generation would result in a deficient ML model, and determining that the target data set is inadequate in a manner related to the determined failure metric; and (c) provide an indication of the determined inadequacy of the target data set.

A second example embodiment, a method is provided that includes: (i) obtaining a target data set; (ii) applying an ML pipeline to the target data set, wherein the ML pipeline includes a data pre-processing phase and an ML model building phase, wherein the data pre-processing phase generates a conditioned data set from the input data set, wherein the ML model building phase generates an ML model from the conditioned data set; (iii) generating a failure metric for at least one phase in the ML pipeline, wherein applying the ML pipeline results in at least one of generation of an ML model from the target data set or determination of an inadequacy of the target data set, wherein determining an inadequacy of the target data set includes determining that generation of the ML model failed or that ML model generation would result in a deficient ML model, and determining that the target data set is inadequate in a manner related to the determined failure metric; and (iv) providing an indication of the determined inadequacy of the target data set

In a third example embodiment, an article of manufacture may include a non-transitory computer-readable medium, having stored thereon program instructions that, upon execution by a computing system, cause the computing system to perform operations in accordance with the second example embodiment.

In a fourth example embodiment, a computing system may include at least one processor, as well as memory and program instructions. The program instructions may be stored in the memory, and upon execution by the at least one processor, cause the computing system to perform operations in accordance with the second example embodiment.

In a fifth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6A depicts a traditional programming procedure, in accordance with example embodiments.

FIG. 6B depicts a machine learning procedure, in accordance with example embodiments.

FIG. 6C depicts a training pipeline for machine learning models, in accordance with example embodiments.

FIG. 7 depicts an incident report, in accordance with example embodiments.

FIG. 8 depicts a system for generating, storing, and analyzing incident reports, in accordance with example embodiments.

FIG. 9 depicts a training data set that includes a plurality of incident reports, in accordance with example embodiments.

FIG. 10 depicts a training pipeline for machine learning models, in accordance with example embodiments.

FIG. 11 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflow for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

The following embodiments describe architectural and functional aspects of example aPaaS systems, as well as the features and advantages thereof.

### II. Example Computing Devices and Cloud-Based Computing Environments

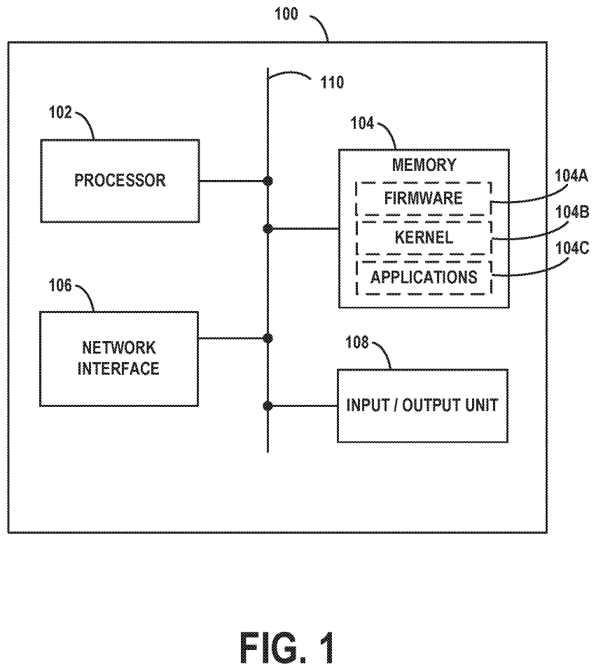

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and an input/output unit 108, all of which may be coupled by a system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and busses), of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

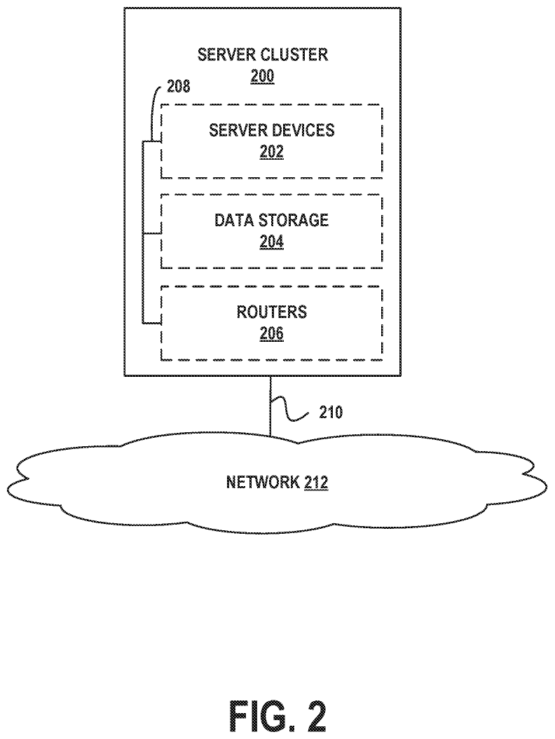

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purpose of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between the server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JavaScript, and so on. Computer program code written in these languages may facilitate the providing of web pages to client devices, as well as client device interaction with the web pages.

### III. Example Remote Network Management Architecture

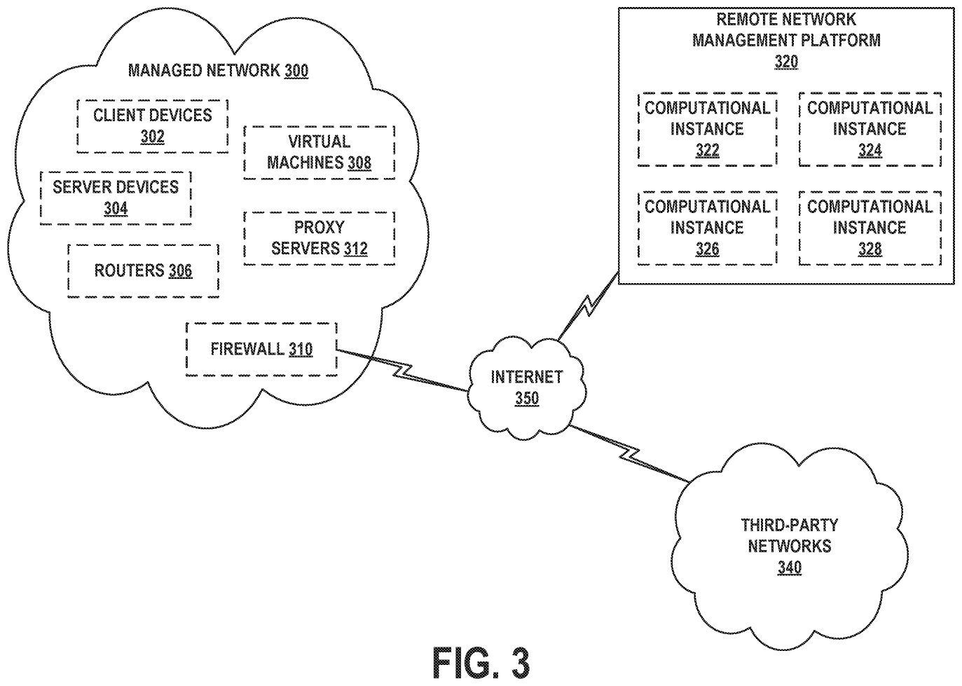

FIG. 3 depicts a remote network management architecture, in accordance with example embodiments. This architecture includes three main components, managed network 300, remote network management platform 320, and third-party networks 340, all connected by way of Internet 350.

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server device that facilitates communication and movement of data between managed network 300, remote network management platform 320, and third-party networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of third-party networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

Remote network management platform 320 is a hosted environment that provides aPaaS services to users, particularly to the operators of managed network 300. These services may take the form of web-based portals, for instance. Thus, a user can securely access remote network management platform 320 from, for instance, client devices 302, or potentially from a client device outside of managed network 300. By way of the web-based portals, users may design, test, and deploy applications, generate reports, view analytics, and perform other tasks.

As shown in FIG. 3, remote network management platform 320 includes four computational instances 322, 324, 326, and 328. Each of these instances may represent one or more server devices and/or one or more databases that provide a set of web portals, services, and applications (e.g., a wholly-functioning aPaaS system) available to a particular customer. In some cases, a single customer may use multiple computational instances. For example, managed network 300 may be an enterprise customer of remote network management platform 320, and may use computational instances 322, 324, and 326. The reason for providing multiple instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows with one or more database tables).

For purpose of clarity, the disclosure herein refers to the physical hardware, software, and arrangement thereof as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may impact all customers' data, creating additional risk, especially for entities subject to governmental, healthcare, and/or financial regulation. Furthermore, any database operations that impact one customer will likely impact all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of physical or virtual servers and database devices. Such a central instance may serve as a repository for data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate a virtual machine that dedicates varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

Third-party networks 340 may be remote server devices (e.g., a plurality of server clusters such as server cluster 200) that can be used for outsourced computational, data storage, communication, and service hosting operations. These servers may be virtualized (i.e., the servers may be virtual machines). Examples of third-party networks 340 may include AMAZON WEB SERVICES® and MICROSOFT® Azure. Like remote network management platform 320, multiple server clusters supporting third-party networks 340 may be deployed at geographically diverse locations for purposes of load balancing, redundancy, and/or high availability.

Managed network 300 may use one or more of third-party networks 340 to deploy applications and services to its clients and customers. For instance, if managed network 300 provides online music streaming services, third-party networks 340 may store the music files and provide web interface and streaming capabilities. In this way, the enterprise of managed network 300 does not have to build and maintain its own servers for these operations.

Remote network management platform 320 may include modules that integrate with third-party networks 340 to expose virtual machines and managed services therein to managed network 300. The modules may allow users to request virtual resources and provide flexible reporting for third-party networks 340. In order to establish this functionality, a user from managed network 300 might first establish an account with third-party networks 340, and request a set of associated resources. Then, the user may enter the account information into the appropriate modules of remote network management platform 320. These modules may then automatically discover the manageable resources in the account, and also provide reports related to usage, performance, and billing.

Internet 350 may represent a portion of the global Internet. However, Internet 350 may alternatively represent a different type of network, such as a private wide-area or local-area packet-switched network.

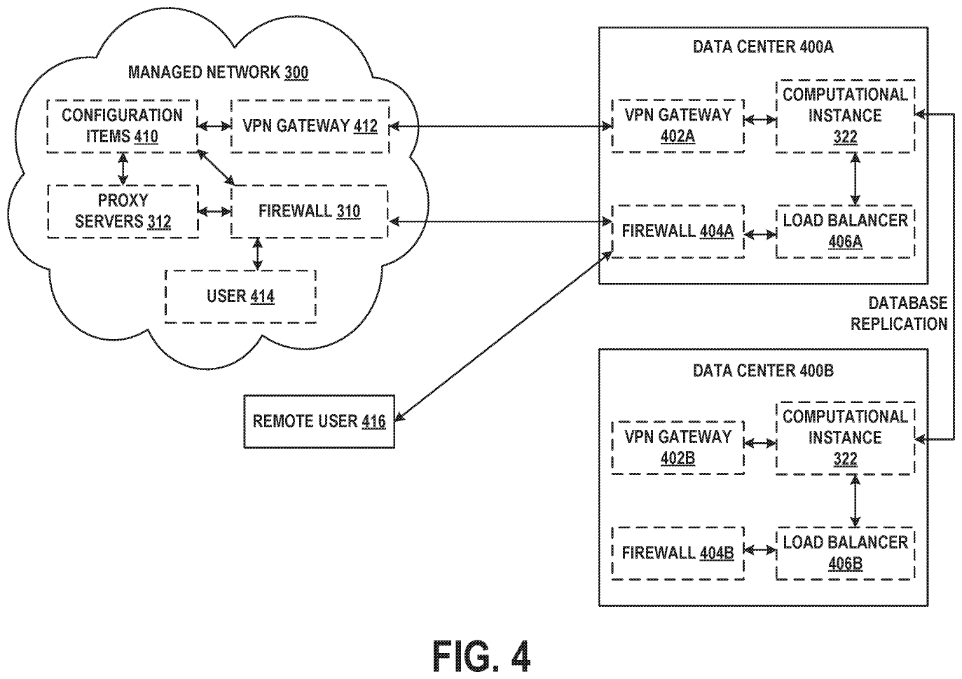

FIG. 4 further illustrates the communication environment between managed network 300 and computational instance 322, and introduces additional features and alternative embodiments. In FIG. 4, computational instance 322 is replicated across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. Example Device, Application, and Service Discovery

In order for remote network management platform 320 to administer the devices, applications, and services of managed network 300, remote network management platform 320 may first determine what devices are present in managed network 300, the configurations and operational statuses of these devices, and the applications and services provided by the devices, and well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purpose of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

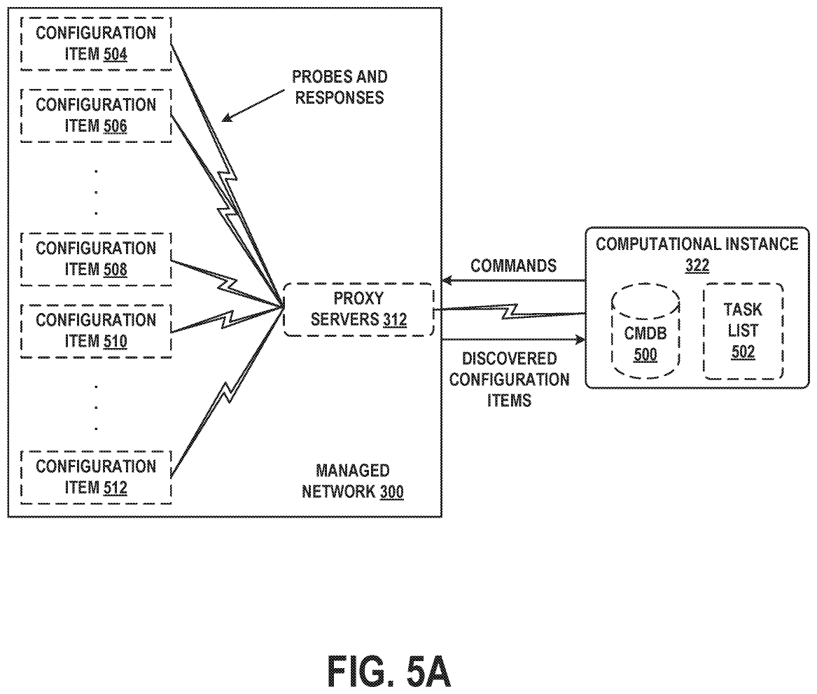

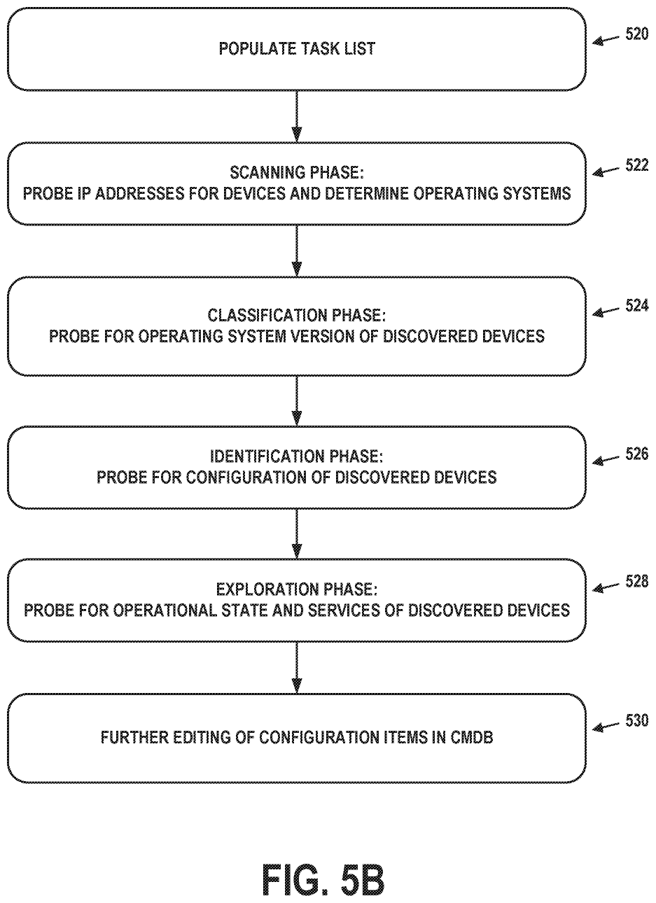

FIG. 5A provides a logical depiction of how configuration items can be discovered, as well as how information related to discovered configuration items can be stored. For sake of simplicity, remote network management platform 320, third-party networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For instance, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are for purpose of example. Discovery may be a highly configurable procedure that can have more or fewer phases, and the operations of each phase may vary. In some cases, one or more phases may be customized, or may otherwise deviate from the exemplary descriptions above.

### V. Machine Learning Systems

Machine learning (ML) can be integrated into a remote network management platform in a number of ways. For example, a central computational instance may provide ML training (e.g., generation of ML models) and/or production (e.g., execution of ML models against specified input) on behalf of one or more computational instances. Alternatively, the computational instances may operate the ML training and/or ML production themselves.

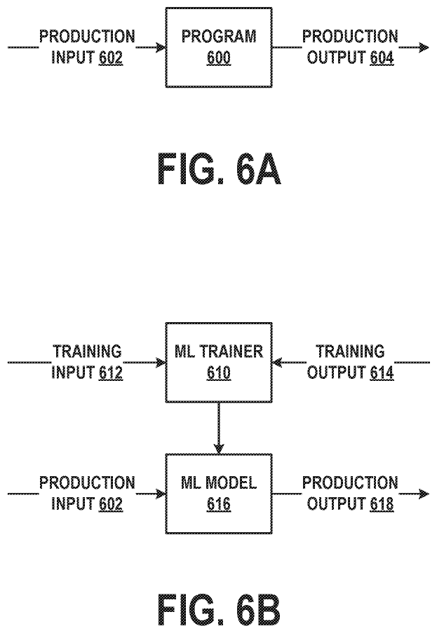

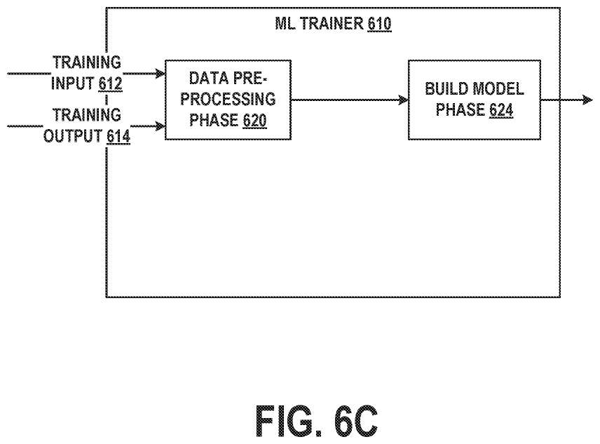

Regardless, the development cycle for ML systems differs significantly from that of traditional programming. Throughout most of the existence of software engineering, programs were developed according to the process illustrated by FIG. 6A. A program 600 was written and tested so that it could receive production input 602 and produce production output 604. Here, “production input” refers to input found in real-world deployments of program 600, and “production output” refers to the output generated by program 600 in response to receiving production input.

Not shown in FIG. 6A is any testing input and its associated testing output that may be used in a similar fashion during development and testing procedures of program 600. Any such testing input could be synthetically or manually generated, for example, with the goal of ensuring that program 600 behaves as expected when subjected to a range of input.

The development of program 600 involves considering possible values of production input 602 and determining what production output 604 should entail as a results of processing this input. In other words, production input 602 is assumed to be well-defined, and the transformation that maps production input 602 to production output 604 is assumed to be tractable enough to specify algorithmically. More formally, if i represents production input 602 and o represents production output 604, the goal of developing program 600 is to find a function, ƒ, such that o=ƒ(i).

But not all problems can be characterized in a fashion that is conducive to such a mapping. For example, so-called “NP hard” problems do not have polynomial-time solutions, and the best that one can hope for are polynomial-time approximations that produce sufficient solutions most of the time. But these approximation algorithms are often difficult to design and develop. Another class of problems that have proven challenging for traditional programming techniques are those that attempt to simulate complex human sensory processing, such as speech recognition, natural language processing, image recognition, and so on.

FIG. 6B depicts a different software engineering process. An ML trainer 610 is a program that takes in training input 612 and training output 614. There often is a one-to-one mapping between each unit of training input 612 and a unit of training output 614, though more complex mappings are possible. Further, it is assumed that training input 612 and training output 614, which are usually combined into a single training data set, is quite large with a significant number of such mappings (e.g., hundreds, thousands, or even millions). This training data set may be referred to as having labeled data, in that each input is labeled with its respective ground-truth output value.

The goal of ML trainer 610 is to iteratively analyze the mappings to build a computational ML model 616 (e.g., an algorithm) that can, with high probability, produce the training output 614 from training input 612. In other words, for each unit of training input 612, the associated unit of training output 614 will be produced in the vast majority of instances. Furthermore, ML model 616 may be able to produce desirable output even from input that was not used during its training.

The types of models and methods through which these models can be trained vary dramatically. For instance, ML model 616 could be an artificial neural network, decision tree, random forest, support vector machine, Bayes classifier, k-means clusterer, linear regression predictor, and so on. But the embodiments herein may be operable with any type of machine learning technique.

Once tested, ML model 616 may be placed into production. Thus, like program 600, ML model 616 may receive production input 602. However, ML model 616 may produce production output 618 that is different from production output 604. As alluded to above, a well-trained ML model can often produce production output that is superior to that of a traditionally-developed algorithm.

Nonetheless, training ML model 616 can be highly sensitive to the quality of training input 612 and training output 614. If the training data set does not supply a sufficient amount of data or data with sufficiently representative distributions of data, ML model 616 may fail to produce meaningful output. For example, if a particular parameter of the training data set is constant, then ML model 616 may not be able to produce desirable production output when this parameter takes on other values.

Thus, ML trainer 610 may be implemented as a multi-stage pipeline as depicted in FIG. 6C. As shown, ML training includes two phases: data pre-processing phase 620 and build model phase 624. But in general, ML training may contain more or fewer phases. For example, the ML trainer 610 may include a model utility validation phase to determine whether a chosen ML model architecture is likely to provide benefits (e.g., predictive accuracy) relative to a model having fewer trainable parameters or that is otherwise less complex than the chosen ML model architecture.

Further, individual phases of the ML training pipeline may include a variety of sub-phases. Data pre-processing phase 620 takes training input 612 and training output 614, and then analyzes and transforms this training data set into a conditioned data set that can be used to generate an ML model. To do this, data pre-processing phase 620 may include sub-phases to remove duplicate entries, determine whether any parameters in the training data set have constant values, scale or otherwise transform the values of the data set (e.g., to normalize them, to fit them to a specified numerical range, to cause them to comport with a specified distribution, to orthogonalize columns or other variables of the input training dataset, to perform a dimensionality reduction on one or more columns or other variables of the input training dataset), determine the density of one or more such parameters, and/or determine the distribution of values of one or more such parameters. Additional analysis may occur, and the operations of data pre-processing phase 620 are not limited to those discussed herein.

The conditioned data set generated by the data pre-processing phase 620 is then provided to the build model phase 622. The build model phase attempts to generate an ML model based on the conditioned data set that reflects the information present in the input data set (e.g., the structure of the inter-relationships between the columns or other variables of the conditioned data set and one or more output variables which may be, themselves, columns of the conditioned data set). The build model phase 624 may include one or more of a variety of methods used to train ML models, e.g., reinforcement learning, gradient descent, backpropagation, genetic algorithms, dynamic programming, simulated annealing, model hyperparameter estimation, pruning, or other methods.

In some examples, the ML trainer 610 may include steps for early termination of the model build process (e.g., for not performing the build model phase 624). This may be advantageous as the building of an ML model can be computationally expensive with respect to, e.g., processing cycles, number of processor cores or other computational units, and/or memory. This is particularly the case when the training data set is large and/or the ML model includes many parameters and/or hyperparameters such that the build model phase 624 may take hours or days to complete. These steps may include determining, at one or more steps in the ML training pipeline, failure metric(s) and then, based on the failure metric(s), determining that the ML model generation process is likely to fail or to result in a deficient ML model.

Failure of the ML model generation process may include the model generation process failing to converge on a stable set of model parameter values (e.g., by oscillating or by failing to converge within a specified time/number of iterations) or failing by some other process. A “deficient ML model” is an ML model that fails to accurately model the provided training data, that is over-fitted to the provided training data (e.g., such that the ML model is inaccurate when predicting novel data not present in the training data), that only predicts a single output class regardless of the proved input, that fails to produce certain output classes from a set of possible output classes for any provided input, or that is deficient in some other respect.

A. Example Training Data and Representation Thereof

In order to illustrate training data sets and to explain in more detail what is meant by parameter density and distribution, an example data set is provided below. While this data set is from a particular problem domain (IT incident management), other data sets relevant to other problem domains may be used.

Natural language processing is a discipline that involves, among other activities, using computers to understand the structure and meaning of human language. This determined structure and meaning may be applicable to the processing of IT incidents, as described below. But incident reports may relate to information other that IT incidents, and may encompass customer service management uses and other uses as well.

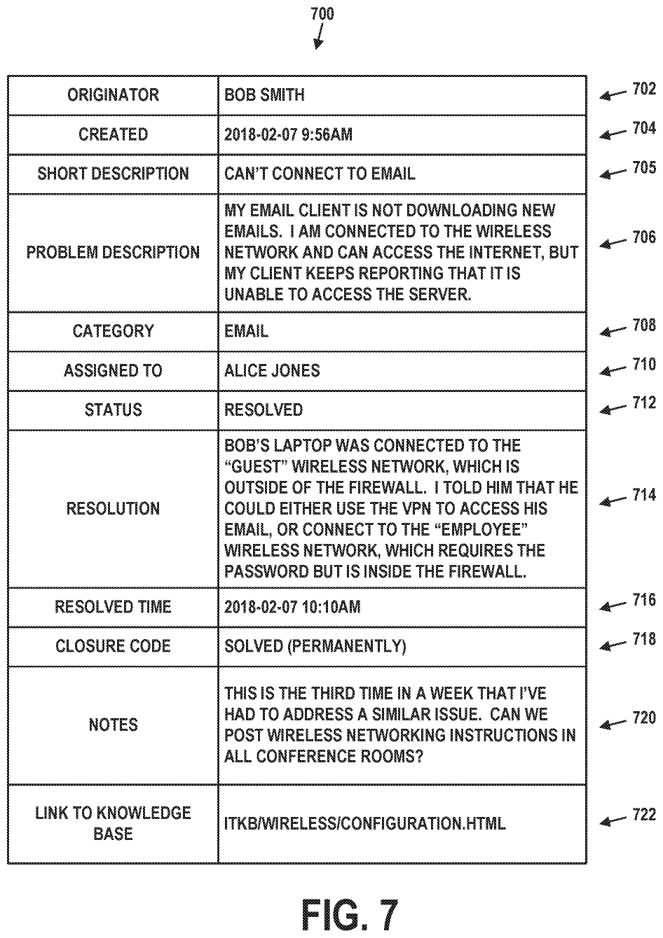

Each incident may be represented as an incident report. While incident reports may exist in various formats and contain various types of information, an example incident report 700 is shown in FIG. 7. Incident report 700 consists of a number of fields in the left column, at least some of which are associated with values in the right column.

Field 702 identifies the originator of the incident report, in this case Bob Smith. Field 704 identifies the time at which the incident report was created, in this case 9:56 AM on Feb. 7, 2018. Field 705 is a text string that provides a short description of the problem. Field 706 identifies the description of the problem, as provided by the originator. Thus, field 706 may be a free-form text string containing anywhere from a few words to several sentences or more. Field 708 is a categorization of the incident, in this case email. This categorization may be provided by the originator, the IT personnel to whom the incident report is assigned, or automatically based on the context of the problem description field.

Field 710 identifies the IT personnel to whom the incident report is assigned (if applicable), in this case Alice Jones. Field 712 identifies the status of the incident report. The status may be one of “open,” “assigned,” “working,” or “resolved” for instance. Field 714 identifies how the incident report was resolved (if applicable). This field may be filled out by the IT personnel to whom the incident report is assigned or another individual. Field 716 identifies the time at which the incident report was resolved, in this case 10:10 AM on Feb. 7, 2018. Field 718 specifies the closure code of the incident (if applicable) and can take on values such as “closed (permanently)”, “closed (work around)”, “closed (cannot reproduce)”, etc. Field 720 identifies any additional notes added to the record, such as by the IT personnel to whom the incident report is assigned. Field 722 identifies a link to an online article that may help users avoid having to address a similar issue in the future.

In some examples, one or more of the fields may contain word vectors and/or paragraph vectors representing semantic content of, e.g., one or more of the other field(s). Additionally or alternatively, such word vectors and/or paragraphs vectors could be generated, as part of a data pre-processing phase (e.g., 620) of a machine learning pipeline. Word vectors and paragraph vectors represent the overall “meaning” of corresponding words or collections of words (e.g., phrases, sentences, paragraphs), respectively. They do this by projecting into a semantically-encoded multidimensional vector space such that words and/or paragraphs having similar “meaning” are proximate to each other in the semantically-encoded multidimensional vector space (e.g., with respect to a Euclidean distance in the multidimensional vector space) while words and/or paragraphs having dissimilar “meanings” are distant from each other in the semantically-encoded multidimensional vector space. So, for example, word vectors for the words “uncle” and “aunt,” or for the words “car” and “automobile,” would be closer to each other, within the multidimensional vector space, than the word vectors for “duck” and “hypotenuse,” or for “flange” and “blancmange.”

A word vector for a particular word (e.g., a word present in one of the fields of the incident report 700) could be determined by looking up the word vector in a lookup table or other index mapping words to word vectors. Such a mapping may be generated in a variety of ways, e.g., by training a multi-layer perceptron or other ML model architecture using samples of natural language. The trained ML model includes an input layer that represents the mapping between input words and corresponding word vectors. The ML model could be configured and trained to predict words based on their context, e.g., to predict the next word in a sequence of words (e.g., the next word in a sentence) based on a number of prior words. In the event a novel word is encountered (e.g., that was not present in the corpus of text used to generate the mapping for the word vectors), supplemental training could be performed to augment the existing mapping (e.g., based on samples of natural language that include the additional word). Paragraph vectors may be determined, for multi-word samples of text, via similar methods.

In an example, one of the fields of the incident report 700 could contain a paragraph vector that represents, in a semantically-encoded vector space, the overall meaning of the “notes” field 720, the “resolution” field 714, the “problem description” field 706, or some other field or combination of fields. In another example, one of the fields could contain a set of word vectors for each of the words, or for the top n most-commonly-used words, in one or more of the fields.

Incident report 700 is presented for purpose of example. Other types of incident reports may be used, and these reports may contain more, fewer, and/or different fields.

Incident reports, such as incident report 700, may be created in various ways. For instance, by way of a web form, an email sent to a designated address, a voicemail box using speech-to-text conversion, and so on. These incident reports may be stored in an incident report database that can be queried. As an example, a query in the form of a text string could return one or more incident reports that contain the words in the text string.

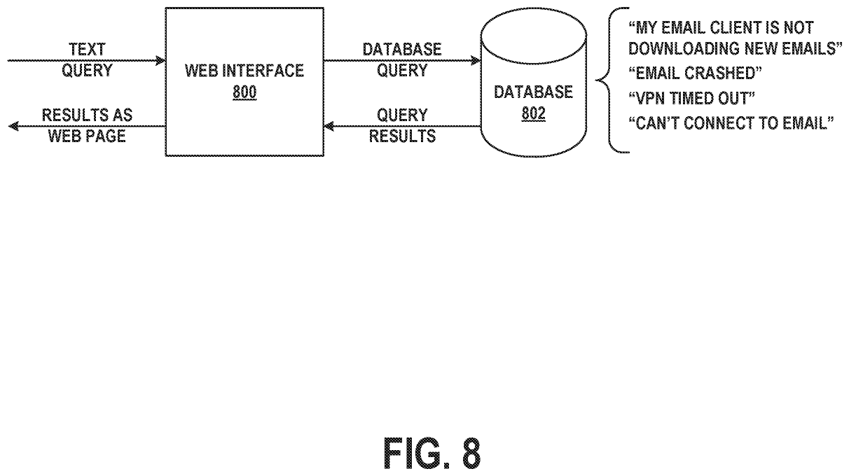

This process is illustrated in FIG. 8. A text query may be entered into web interface 900. This web interface may be supplied by way of a computational instance of remote network management platform 320. Web interface 800 converts the text query into a database query (e.g., an SQL query), and provides the SQL query to database 802. This database may be CMDB 500 or some other database. Database 802 contains a number of incident reports with problem description fields as shown in FIG. 7. Regardless, database 802 conducts the query and returns matching results to web interface 800. One or more such results may be returned. Web interface 900 provides these results as a web page.

For example, if the text query is “email”, web interface 800 may convert this query into an SQL query of database 802. For example, the query may look at the problem description field of a table containing incident reports. Any such incident report that matches the query—i.e., includes the term “email”—may be provided in the query results. Thus, the incident reports with the problem descriptions of “My email client is not downloading new emails”, “Email crashed”, and “Can't connect to email” may be provided, while the incident report with the problem description “VPN timed out” is not returned.

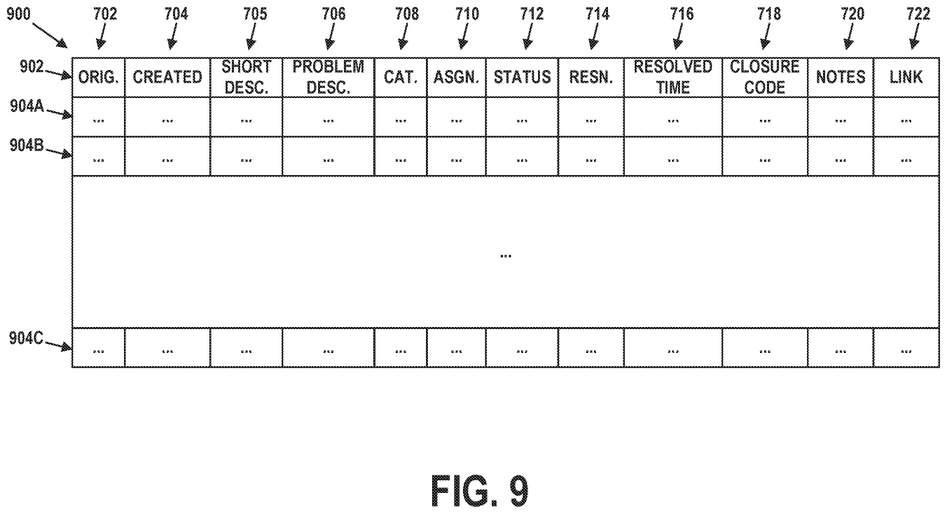

FIG. 9 depicts a database table 900 for storing incident reports. The structure of table 900 may be used in database 802, for example.

The information in table 900 is arranged logically as a set of columns 902. Each of these columns corresponds to a field of incident report 700. Thus, the first column represents field 702 (originator of the incident report), the second column represents field 704 (the time at which the incident report was created), and so on. Each incident report is represented as an entry in table 900, in the form of a row. Thus, row 904A may specific one incident report (e.g., the content of incident report 700), row 904B may specify another incident report, and row 904C may specify yet another incident report. As is implied in FIG. 9, table 900 may contain numerous rows, perhaps hundreds, thousands, or millions.

The example of table 900 will be used below to illustrate the embodiments disclosed herein. Nonetheless, these embodiments may operate on other types of data in other arrangements.

### VI. Example Failure Metrics

The process of generating an ML model from a set of training data (e.g., using an ML training pipeline 610) can be expensive with respect to the amount of servers, processor cores, processor cycles, memory, or other computational resources used to generate the ML model. Additionally, in examples where the ML model generation fails and/or the generated ML model in inadequate in some manner, it can be difficult to determine the factor(s) responsible for the failure in order for a user to rectify them (e.g., by providing additional training data, by removing certain columns/variables from the training data).

Accordingly, it is advantageous to generate, at a variety of points within an ML pipeline, metrics related to the likelihood of failure (or success) of the ML pipeline in generating an ML model. Additionally or alternatively, such metrics may be related to those factors of the training data and/or of the ML training process itself that are likely to have a bearing on the success or failure of the pipeline in generating the ML model. In the event of failure, these metrics can be analyzed in order to determine potential cause(s) of the failure, such that they can be rectified for future attempts. Additionally or alternatively, these metrics can be analyzed prior to or during ML model generation in order to pre-emptively terminate model generation, e.g., when the metric(s) indicate that it is likely that the ML model generation will fail and/or result in an ML model that is inadequate in some manner.

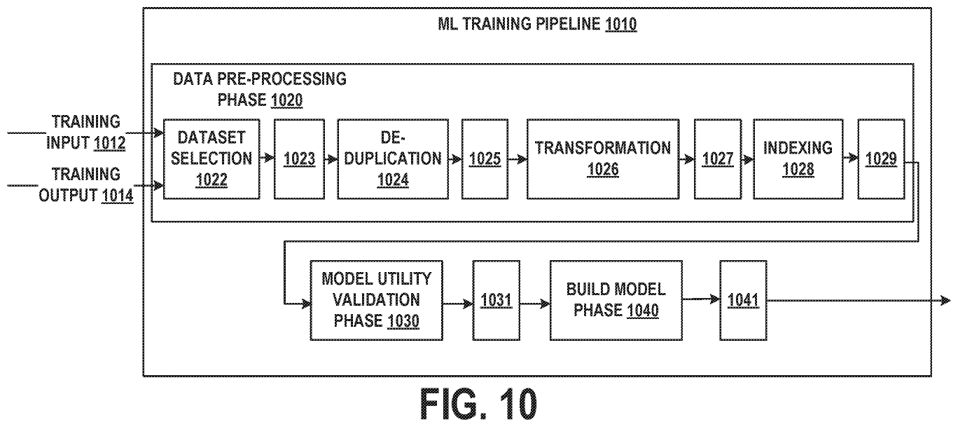

FIG. 10 depicts an example ML training pipeline 1010 that takes in training input 1012 and training output 1014. The goal of ML training pipeline 1010 is to build a computational ML model (e.g., 616) that can generate the training output 1014 from the training input 1012. In other words, for each unit of training input 1012, the generated ML model should produce the associated unit of training output 1014 in the vast majority of instances. Additionally, the structure of the ML model and the nature of the training can result in the generated ML model being able to produce desirable output even from novel input that was not used or otherwise available during its training.

The ML training pipeline 1010 could be configured to generate an artificial neural network, a decision tree, a random forest, a support vector machine, a Bayes classifier, a k-means clusterer, a linear regression predictor, or some other machine learning structure or combination of machine learning structures as part of the generated ML model (e.g., to generate a number of artificial neural networks that provide outputs to a support vector machine that, in turn, generated the output(s) of the ML model). The ML training pipeline 1010 could be configured to generate the ML model using a variety of training algorithms (e.g., reinforcement learning, gradient descent, backpropagation, genetic algorithms, dynamic programming, simulated annealing, model hyperparameter estimation, pruning, or other methods) operating on a variety of cost functions or other goal criteria (e.g., least-squares error, triplet error, etc.). But the embodiments herein may be operable with any type of machine learning technique or machine learning model architecture.

The ML training pipeline 1010 includes a data pre-processing phase 1020 that generates a conditioned data set from the training input 1012 and training output 1014 that, together, represent an input data set to the ML training pipeline 1010. As shown in FIG. 10, the data pre-processing phase 1020 can include selecting a subset of the input training data (dataset selection 1022). This can include selecting, from the input training data set 1012, 1014, a subset of the entries in the input data set that satisfy one or more criteria, e.g., that have date information within a specified range of dates/times, that were generated by a specified person or set of people, that have a category, status, or other property that comports with a specified category, status, or other property, and/or that comport with some other specification.

The data pre-processing phase 1020 depicted in FIG. 10 also includes removing repeated entries from the selected input data set (de-duplication 1024). This can include removing, for entries that are identical to each other, all but one of the identical entries from the training data set. In some examples, the entries being “identical” could be determined based only on a subset of the fields/columns of the input data set (e.g., to disregard entries in the data set that differ from each other with respect to fields that are not going to be analyzed).

The data pre-processing phase 1020 depicted in FIG. 10 also includes transforming the input data set (transformation 1026). This can include scaling, shifting, or applying some other equation to the values in one or more fields/columns of the input data set. For example, the values of one or more columns could be scaled and shifted to lie within the range of zero to one, e.g., to make the data compatible with the inputs of a neural network of the ML model to be generated. The information in one or more fields/columns of the input data set could be counted, indexed, sorted, binned, or otherwise manipulated in order to determine a probability distribution or other statistical information for the fields/columns. Additionally or alternatively, the values or other data in the fields/columns could be scaled, shifted, nonlinearly modified, or otherwise transformed such that the values comport with a specified distribution. For example, the values in a column of the input data set could be scaled and shifted such that the values correspond to a normal distribution having a specified mean and/or variance.

In some examples, transforming the input data set 1026 as part of generating a conditioned data set can include transforming the values or other information in multiple fields/columns of the input data set together with each other. For example, the values in multiple fields of the data set could be considered as scalars within a single vector for each of the entries in the input data set, and the data could be ‘rotated’ in order to, e.g., orthogonalize the data in the multiple fields. Such orthogonalization could be performed in order to speed the ML model building process by providing fields of data (and thus respective ML model input variables) that are more independent from each other statistically. Additionally or alternatively, the values in values in multiple fields of the data set could be considered as scalars within a single vector for each of the entries in the input data set, and the data could be subjected to a dimensionality reduction process. Such dimensionality reduction could be performed in order to speed the ML model building process by providing fewer fields of data (and thus respective ML model input variables) that may provide a substantial fraction of the predictive information that was present in the multiple fields of information to which the dimensionality reduction process was applied.

The data pre-processing phase 1020 depicted in FIG. 10 also includes indexing the input data set (indexing 1028). This can include sorting the entries in the input data set (e.g., according to the values in one or more of the fields/columns of the data set, according to a date or time associated with each of the entries), determining a hash for each of the entries and/or for information of the entries, generating a tree or other data structure for quickly accessing and/or manipulating the elements of the input data set, or performing some other operations to index the contents of the input data set. The indexing could be performed in order to speed the process of generating an ML model from the input data set (e.g., by making entries in the data set that are more likely to be accessed easier to access).

The ML model building pipeline 1010 additionally includes a model utility validation phase (model utility validation phase 1030). This phase operates to determine, based on the conditioned data set generated by the data pre-processing phase 1020, whether the ML model building pipeline 1010 is likely (e.g., more likely than a threshold likelihood) to generate an ML model that is sufficiently valuable. To accomplish this determination, the model utility validation phase 1030 generates, based on the conditioned data set, a first test model according to the specified architecture and configuration of the ML model to be built. The model utility validation phase 1030 additionally generates, based on the conditioned data set, second, simplified test model that is less complex than the first test model. That is, the second test model may include fewer trainable parameters, fewer layers (e.g., of a multilayer neural network), fewer nodes (e.g., of a neural network), less connectivity between units/layers of the ML model, fewer clusters, or be otherwise simplified.

The ability of the first and second test models to accurately predict the conditioned test data is then compared. If the predictive ability (e.g., accuracy) of the first model fails to exceed the predictive ability of the second, simplified model by more than a threshold amount, the model utility validation phase 1030 could determine that the ML model building pipeline 1010 is unlikely to generate an ML model that is sufficiently valuable to justify the cost of building the ML model. In response, the ML building pipeline 1010 could be terminated. Alternatively, an alternative ML model architecture/structure could be selected and built.

In order to reduce the time and expense of such model generation processes, the training applied by the model utility validation phase 1030 may be restricted (e.g., set to a small number of training iterations, using a subset of the conditioned data set) relative to the process used to build the full ML model, pending the outcome of the model utility validation phase 1030.

The ML model building pipeline 1010 additionally includes an ML model building phase (build model phase 1040). This phase operates to generate the full ML model based on the conditioned data set generated by the data pre-processing phase 1020. The execution of the model building phase 1040 may be contingent on the outcome of the model utility validation phase 1030, on an analysis of one or more model failure metrics generated based on the output(s) of previous phases or sub-phases of the ML model building pipeline 1010, or may be contingent on some other circumstance.

Note that the ML model building pipeline 1010 and the sub-phases of the data pre-processing phase 1020 thereof are intended as non-limiting example embodiments. An ML model building pipeline as described herein could include more or fewer phases (e.g., could omit the model utility validation phase). Additionally or alternatively, the data pre-processing phase of an ML model building pipeline as described herein could include more, fewer, and/or different sub-phases than those depicted in FIG. 10.

In order to determine whether the ML model building pipeline 1010 has failed, is likely to fail, and/or in order to determine one or more factors (e.g., properties of the input dataset, settings of the ML pipeline, and/or characteristics of the ML model) that likely contributed to the failure of the ML model pipeline, failure metrics can be determined at one or more points along the ML model building pipeline 1010. For example, one or more failure metrics could be determined after the dataset selection sub-phase (1023), after the de-duplication sub-phase (1025), after the transformation sub-phase (1027), after the indexing sub-phase (1029), after the model utility validation phase (1031), after the ML model build phase (1041), and/or at some other point in the ML model building process. A failure metric can be determined, at a particular phase of the ML pipeline, based on one or more properties of the data or other information (e.g., ML model parameters) input to the phase and/or the data or other information output from the phase that is related to adequacy of the data set and/or the overall likelihood that the ML pipeline will generate a non-deficient ML model.

Thus, a failure metric as described herein may take many forms. In some examples, determining a failure metric could include determining statistics for fields/columns of an input data set and/or of a data set that has been generated from an input data set (e.g., a conditioned data set). For example, a number or percentage of entries in a column/field of a data set that are empty (e.g., that include a value indicative of the lack of available data for that entry in that field/column). If all of the field/column's entries are empty, or more than a threshold amount (e.g., a threshold percentage) of the field/column's entries are empty, and/or fewer than a threshold amount are not empty, it could be more likely that a sufficient ML model (that is, a non-deficient ML model) could be determined based on that field/column (e.g., due to insufficient data upon which to build the ML model).

In another example, determining the failure metric could include determining a number of rows/entries in the input data set. For example, determining a failure metric could include determining that the data set contains fewer than a threshold number of rows/entries. If there are too few rows/entries, it could be less likely that a sufficient ML model could be determined (e.g., due to insufficiently diverse data upon which to build the ML model). Additionally or alternatively, determining a failure metric could include determining that the data set contains more than a threshold number of rows/entries. If there are many few rows/entries, it could be less likely that a sufficient ML model could be determined. This could be due to the system running out of memory, running out of budgeted computational resources (e.g., number of cycles, number of processor-hours). Such a maximum-entry-number threshold could be determined based on information about the system hosting the ML pipeline, e.g., based on a total amount of memory of the system, an amount of free memory of the system, a computer budget allocated to generate the ML model, a total number of available processor cores in the system, a number of free processor cores in the system, or some other information about the configuration and/or operation of the system used to run the ML model building pipeline.

In yet another example, determining the failure metric could include determining a distribution of values, categories, or other contents of the entries in a field/column of the data set. For example, determining a failure metric could include determining whether a particular field/column contains only a single unique value. Additionally or alternatively, determining a failure metric could include determining whether a particular field/column contains values that are skewed beyond a threshold amount, e.g., that a majority category or value represents more than 60% of the entries, more than 80% of the entries, or more than 90% of the entries. In another example, a neural network, regression model, or other algorithm could be trained, based on the statistics of past failed and/or successful executions of the ML pipeline, to determine whether the skewness of a particular field/column is likely to lead to ML pipeline failure and/or the generation of an insufficient ML model. If a particular field/column includes only a single value and/or contains values that are too skewed, it could be more likely that a sufficient ML model could be determined based on that field/column (e.g., due to insufficiently diverse data upon which to build the ML model). This may be especially true in cases where the ML model is to built to predict the data in the field/column. In order to compensate for such skewness, entries/rows of the data that belong to the majority class may be removed and/or other remedial actions could be taken.

In yet another example, determining the failure metric could include determining how many entries in an input data set are unique. For example, determining a failure metric could include, subsequent to removing duplicate entries from an input data set, determining that there are less than a threshold amount (e.g., a threshold number) of unique entries in the de-duplicated data set. If there are too few unique entries in the input data set, it could be more likely that a sufficient ML model could be determined based on the selected input data set (e.g., due to insufficiently diverse data upon which to build the ML model).

The determined failure metric(s) can then be used to determine whether to terminate the ML pipeline early (e.g., by comparing the failure metric(s) to a threshold, a baseline distribution, or some other information indicative of properties of the metric for “successful” or “unsuccessful” ML model builds) and/or to provide an indication of the failure metric that caused the termination. Additionally or alternatively, determined failure metric(s) can be used to determine a manner, related to the determined failure metric(s), in which the input data set is inadequate. The inadequacy of the input data set determined in this manner (e.g., too few unique entries in the data set, too many empty values in a particular column/field of the data set, a single unique value across the entries of a particular column/field of the data set, values across the entries of a particular column/field of the data set being too skewed) can be indicated (e.g., to an operator of the ML pipeline). In response to such an indication, the data set may be remediated to facilitate a successful ML build process (e.g., by providing additional training data, by selecting different fields/columns of the data set to use at inputs/outputs to the ML model, by changing a criterion used to select the input data set from a larger set of training data).

A variety of methods could be applied to generate the thresholds, baseline distributions, or other criteria used to determine, based on a failure metric, whether to terminate the ML pipeline and/or to determine that the input data set is inadequate in a manner related to the failure metric. For example, a threshold could be determined manually. In another example, failure metrics could be determined, for a particular stage in an ML pipeline, across a plurality of applications of the ML pipeline. The “success” status of the applications of the ML pipeline could also be recorded. A threshold or other determinative information could then be determined based on the “success” status and the corresponding failure metrics. For example, a threshold could be determined for a particular failure metric, based on the recorded set of failure metrics, such that ML pipeline applications that exhibited failure metric values above the threshold were more likely than a specified probability (e.g., 25%, 50%) to fail in ML model generation and/or to generate an ML model that was deficient in some manner.

Note that more than one failure metric may be used to determine whether to terminate an ML model build early and/or more than one failure metric may be indicated in response to ML build failure. This could include generating a weighted combination of such multiple failure metrics and comparing the combination to a threshold, applying the multiple failure metrics to an artificial neural network or other ML model, or combining the multiple failure metrics in some other way to motivate early termination of an ML pipeline and/or to determine that the multiple failure metrics are, in combination, likely related to the failure of the ML pipeline and thus to provide an indication (e.g., to an operator of the ML pipeline) of the multiple failure metrics.

### VII. Example Operations

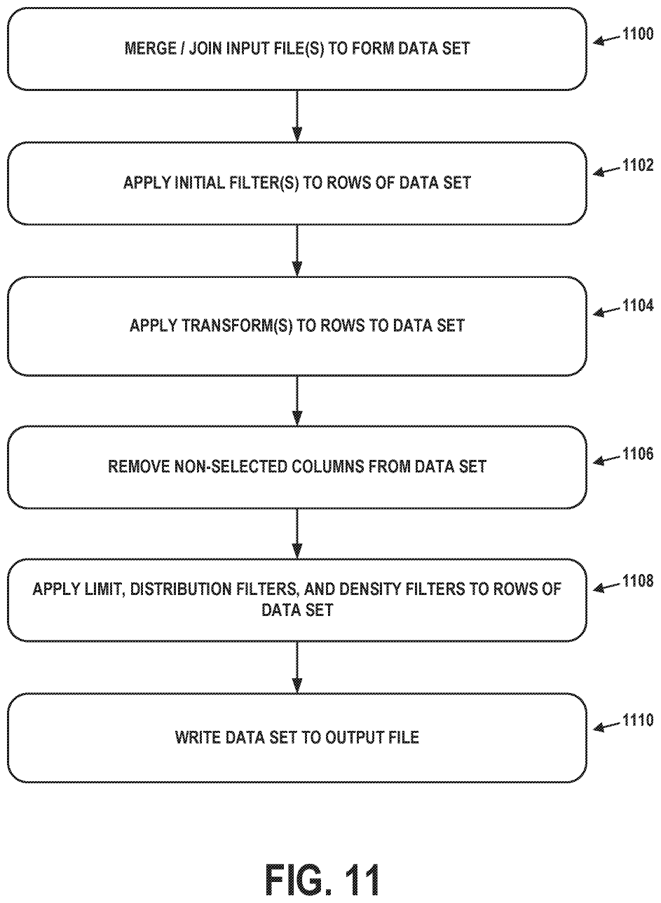

FIG. 11 is a flow chart illustrating an example embodiment. The process illustrated by FIG. 11 may be carried out by a computing device, such as computing device 100, and/or a cluster of computing devices, such as server cluster 200. However, the process can be carried out by other types of devices or device subsystems. For example, the process could be carried out by a portable computer, such as a laptop or a tablet device.

The embodiments of FIG. 11 may be simplified by the removal of any one or more of the features shown therein. Further, these embodiments may be combined with features, aspects, and/or implementations of any of the previous figures or otherwise described herein.

The example method of FIG. 11 includes obtaining a target data set (1100). This could include receiving, from a database, a plurality of incident reports or other records relating to the operation of a computer network environment and/or of services provided as part of such an environment. Obtaining the target data set could include receiving a query of other information defining the target data set from a larger set of data (e.g., a query instructing a system to determine an ML model based on a set of incident reports generated within a specified range of dates).

The example method of FIG. 11 additionally includes applying a machine learning (ML) pipeline to the target data set (1102). The ML pipeline includes a data pre-processing phase and an ML model building phase. The data pre-processing phase generates a conditioned data set from the input data set and the ML model building phase generates an ML model from the conditioned data set. As described elsewhere herein, generating a conditioned data set from the input data set can include a variety of processes, including but not limited to filtering, removing duplicate entries in the data set, selecting a sub-set of the input data (e.g., selecting entries that correspond to a specified range of dates or that comport with some other specified properties), transforming the input data (e.g., to scale and shift values of one or more fields/columns of the input data to lie within a specified range of values), or some other pre-processing task.

The example method of FIG. 11 also includes generating a failure metric for at least one phase in the ML pipeline (1104). Applying the ML pipeline results in at least one of generation of an ML model from the target data set or determination of an inadequacy of the target data set. Determining an inadequacy of the target data set includes (i) determining that generation of the ML model failed or that ML model generation would result in a deficient ML model, and (ii) determining that the target data set is inadequate in a manner related to the generated failure metric.

The example method of FIG. 11 further includes providing an indication of the determined inadequacy of the target data set (1106). This could include providing a human-readable indication (e.g., on a screen of a computer, laptop, tablet, or other device) of the failure metric upon which the determined inadequacy was based. In some examples, multiple failure metrics, inadequacies of the input data set, and/or deficiencies of the ML pipeline related thereto could be indicated.

The example method of FIG. 11 could include additional or alternative steps. For example, the ML pipeline could include performing a model utility validation phase. The method could include determining, based on one or more determined failure metrics, that the ML pipeline was likely to fail in some manner related to the determined failure metric. For example, it could be determined that the pipeline was likely to fail in generating an ML model, to generate an ML model that is deficient in some manner, or to fail in some other manner due to the input data set containing too few unique entries, to one or more columns/fields of the input data set containing too many empty entries and/or too few different values (e.g., a single constant value), to a field/column selected as an output of the ML model being too skewed, to a predicted output of the ML model being too skewed, or some other determined failure metric satisfying some criterion (e.g., exceeding, or failing to exceed, a threshold value). In such an example, the method could additionally include, responsive to such a determination, terminating the ML model building pipeline (e.g., to avoid using computational resources to building an ML model that is unlikely to be valuable).

### VIII. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
a memory containing a target data set;
a software application configured to apply a machine learning (ML) pipeline to an input data set, wherein the ML pipeline includes a data pre-processing phase and an ML model building phase, wherein the data pre-processing phase generates a conditioned data set from the input data set, wherein the ML model building phase generates an ML model from the conditioned data set, and wherein the software application is additionally configured to generate a failure metric for at least one phase in the ML pipeline; and
a computing device configured to:
obtain, from the memory, the target data set;
apply the ML pipeline to the target data set, wherein applying the ML pipeline results in at least one of generation of an ML model from the target data set or determination of an inadequacy of the target data set, wherein determining an inadequacy of the target data set comprises (i) determining that generation of the ML model failed or that ML model generation would result in a deficient ML model, and (ii) determining that the target data set is inadequate in a manner related to the determined failure metric; and
provide an indication of the determined inadequacy of the target data set.

2. The system of claim 1, wherein applying the ML pipeline to the target data set comprises terminating the ML pipeline in response to determining, based on the determined failure metric, that the target data set is inadequate in a manner related to the determined failure metric.

3. The system of claim 1, wherein the target data set is arranged in columns and rows, wherein the columns define fields of the target data set and the rows define entries in the target data set, and wherein generating a failure metric for at least one phase in the ML pipeline comprises determining, for a particular one of the columns of the target data set, at least one of (i) that the particular column is empty; (ii) that more than a threshold amount of the entries in the particular column are empty; (iii) that fewer than a threshold amount of the entries in the particular column are not empty; (iv) that the particular column contains a single unique value; or (v) that the values of the particular column are skewed beyond a threshold amount.

4. The system of claim 1, wherein the particular column contains one of (i) word vectors that describe, in a semantically-encoded vector space, the meaning of respective words, or (ii) paragraph vectors that describe, in a semantically-encoded vector space, the meaning of respective multi-word samples of text.

5. The system of claim 1, wherein the data pre-processing phase of the ML pipeline includes removing duplicate entries from the input data set to generate the conditioned data set, and wherein generating a failure metric for at least one phase in the ML pipeline comprises determining that the target data set comprises less than a threshold amount of unique entries.

6. The system of claim 1, wherein the target data set is arranged in columns and rows, wherein the columns define fields of the target data set and the rows define entries in the target data set, wherein the ML model building phase comprises generating an ML model to predict a particular column of the target data set, and wherein generating a failure metric for at least one phase in the ML pipeline comprises determining that the values of the particular column are skewed beyond a threshold amount.

7. The system of claim 1, wherein the ML pipeline additionally includes a utility validation phase, wherein the utility validation phase comprises:
generating first and second ML models from the conditioned data set, wherein the first ML model corresponds to the ML model generated during the ML model building phase, and wherein the second ML model has fewer trainable parameters than the first ML model; and
comparing the predictive ability of the first ML model and the second ML model.

8. The system of claim 7, wherein applying the ML pipeline to the target data set comprises terminating the ML pipeline in response to determining, based on comparing the predictive ability of the first ML model and the second ML model, that the predictive ability of the first ML model fails to exceed the predictive ability of the second ML model by more than a threshold amount.

9. A method comprising:
obtaining a target data set;
applying a machine learning (ML) pipeline to the target data set, wherein the ML pipeline includes a data pre-processing phase and an ML model building phase, wherein the data pre-processing phase generates a conditioned data set from the input data set, wherein the ML model building phase generates an ML model from the conditioned data set;
generating a failure metric for at least one phase in the ML pipeline, wherein applying the ML pipeline results in at least one of generation of an ML model from the target data set or determination of an inadequacy of the target data set, wherein determining an inadequacy of the target data set comprises (i) determining that generation of the ML model failed or that ML model generation would result in a deficient ML model, and (ii) determining that the target data set is inadequate in a manner related to the generated failure metric; and
providing an indication of the determined inadequacy of the target data set.

10. The method of claim 9, wherein applying the ML pipeline to the target data set comprises terminating the ML pipeline in response to determining, based on the determined failure metric, that the target data set is inadequate in a manner related to the determined failure metric.

11. The method of claim 9, wherein the particular column contains one of (i) word vectors that describe, in a semantically-encoded vector space, the meaning of respective words, or (ii) paragraph vectors that describe, in a semantically-encoded vector space, the meaning of respective multi-word samples of text.

12. The method of claim 9, wherein the data pre-processing phase of the ML pipeline includes removing duplicate entries from the input data set to generate the conditioned data set, and wherein generating a failure metric for at least one phase in the ML pipeline comprises determining that the target data set comprises less than a threshold amount of unique entries.

13. An article of manufacture including a non-transitory computer-readable medium, having stored thereon program instructions that, upon execution by a computing system, cause the computing system to perform operations comprising:
obtaining a target data set;
applying a machine learning (ML) pipeline to the target data set, wherein the ML pipeline includes a data pre-processing phase and an ML model building phase, wherein the data pre-processing phase generates a conditioned data set from the input data set, wherein the ML model building phase generates an ML model from the conditioned data set;
generating a failure metric for at least one phase in the ML pipeline, wherein applying the ML pipeline results in at least one of generation of an ML model from the target data set or determination of an inadequacy of the target data set, wherein determining an inadequacy of the target data set comprises (i) determining that generation of the ML model failed or that ML model generation would result in a deficient ML model, and (ii) determining that the target data set is inadequate in a manner related to the determined failure metric; and
providing an indication of the determined inadequacy of the target data set.

14. The article of manufacture of claim 13, wherein applying the ML pipeline to the target data set comprises terminating the ML pipeline in response to determining, based on the determined failure metric, that the target data set is inadequate in a manner related to the determined failure metric.

15. The article of manufacture of claim 13, wherein the target data set is arranged in columns and rows, wherein the columns define fields of the target data set and the rows define entries in the target data set, and wherein generating a failure metric for at least one phase in the ML pipeline comprises determining, for a particular one of the columns of the target data set, at least one of (i) that the particular column is empty; (ii) that more than a threshold amount of the entries in the particular column are empty; (iii) that fewer than a threshold amount of the entries in the particular column are not empty; (iv) that the particular column contains a single unique value; or (v) that the values of the particular column are skewed beyond a threshold amount.

16. The article of manufacture of claim 13, wherein the particular column contains one of (i) word vectors that describe, in a semantically-encoded vector space, the meaning of respective words, or (ii) paragraph vectors that describe, in a semantically-encoded vector space, the meaning of respective multi-word samples of text.

17. The article of manufacture of claim 13, wherein the data pre-processing phase of the ML pipeline includes removing duplicate entries from the input data set to generate the conditioned data set, and wherein generating a failure metric for at least one phase in the ML pipeline comprises determining that the target data set comprises less than a threshold amount of unique entries.

18. The article of manufacture of claim 13, wherein the target data set is arranged in columns and rows, wherein the columns define fields of the target data set and the rows define entries in the target data set, wherein the ML model building phase comprises generating an ML model to predict a particular column of the target data set, and wherein generating a failure metric for at least one phase in the ML pipeline comprises determining that the values of the particular column are skewed beyond a threshold amount.

19. The article of manufacture of claim 13, wherein the ML pipeline additionally includes a utility validation phase, wherein the utility validation phase comprises:
generating first and second ML models from the conditioned data set, wherein the first ML model corresponds to the ML model generated during the ML model building phase, and wherein the second ML model has fewer trainable parameters than the first ML model; and
comparing the predictive ability of the first ML model and the second ML model.

20. The article of manufacture of claim 19, wherein applying the ML pipeline to the target data set comprises terminating the ML pipeline in response to determining, based on comparing the predictive ability of the first ML model and the second ML model, that the predictive ability of the first ML model fails to exceed the predictive ability of the second ML model by more than a threshold amount.
